(19) United States
(12) Patent Application Publication
(10) Pub. No.: US 2021/0118288 A1
(43) Pub. Date: Apr. 22, 2021

(54) Attention-Based Control of Vehicular Traffic

(71) Applicant: Mitsubishi Electric Research Laboratories, Inc., Cambridge, MA (US)

(72) Inventors: Uros Kalabic, Jamaica Plain, MA (US); Harshal Maske, Brighton, MA (US); Tianshi Chu, Palo Alto, CA (US)

(21) Appl. No.: 16/659,933

(22) Filed: Oct. 22, 2019

(51) Int. Cl. G08G 1/01; G08G 1/07; H04W 4/44; G08G 1/095; G06N 3/04; G06N 3/08

(52) U.S. Cl. CPC G08G 1/0145; G08G 1/0125; G08G 1/07; G05D 1/0088; G08G 1/095; G06N 3/04; G06N 3/08; H04W 4/44

(57) ABSTRACT

A traffic control system transforms traffic data in the control region into the image of the traffic flow, and determines control commands for each controlled machine in the control region by submitting the image of the traffic flow and states of the controlled machine to an attention-based controller trained to focus an attention on a controlled machine and to generate a control command for the controlled machine under attention based on the image of the traffic flow in the control region. The traffic control system transmits the control commands to the controlled machines.

### TECHNICAL FIELD

The invention relates generally to traffic control, and more particularly to decentralized data-driven methods and apparatus for controlling vehicular traffic.

### BACKGROUND

Managing traffic over the nation's roadways is a complex problem. In several metropolitan areas, roadways have reached, and even exceeded, their capacities further complicating the problem. Conventionally, congestion has been improved by changing traffic light timing and building new roads. With the advent of wireless technology and connected components, it has become possible to communicate with vehicles and road infrastructure to make real-time decisions that improve traffic.

For example, Internet of Vehicles (IoV) is a convergence of mobile Internet and Internet of Things (IoT). The IoV enables information gathering, information sharing and information processing to effectively guide and supervise vehicles. The IoV is uniquely different from the IoT because of mobility, safety, V2X communication, energy conservation, security attacks, etc. In the IoV, information and communication technologies are applied in the infrastructure, vehicles and users to manage traffic and vehicle mobility. The IoV aims to provide innovative services and control for traffic management and enable users to be better informed and make safer, more coordinated, and smarter use of transportation networks.

More and more connected vehicles and autonomous vehicles are emerging. The mobility control of these types of vehicles are not only based on drivers' actions, but also based on advanced control technologies using communications, sensors, and optimal control theory. Unlike traditional control mechanisms such as traffic lights and stop signs, the advanced control mechanisms can optimize control efficiency by making real time optimal control decisions.

To that end, there is a need to control vehicles and/or traffic lights collectively to improve the traffic. Model based traffic control is complicated because traffic systems are difficult to model because they involve humans and humans are not automata. Hence, some methods use data-driven techniques, such as reinforcement learning. However, data-driven techniques can suffer from scalability issues and rely on accurate position estimation of different vehicles, see, e.g., “IntelliLight: A Reinforcement Learning Approach for Intelligent Traffic Light Control by Hua Wei, et al. However, even with the advancement of modem technology, accurate position estimation in versatile and dynamic vehicular environments is not always achievable.

Accordingly, there is still a need to provide a method for controlling vehicles traveling on different roads.

### SUMMARY

It is an object of some embodiments to provide a system and a method for traffic control for vehicles traveling on different roads. Additionally, or alternatively, it is another object of some embodiments to optimize control efficiency by making real-time optimal control decisions aimed at reducing traffic congestion on different roads.

Some embodiments are based on the recognition that the complexity of traffic control problem lies in part on a versatility of a state of an open-ended traffic system. Specifically, the vehicular environment is a highly dynamic environment. Besides vehicular dynamics, there are unpredictable environmental dynamics, e.g., movement of objects such as pedestrians and animals, sudden events caused by trees and infrastructure, etc. Therefore, control methods applied to vehicular traffic need to be rapidly adaptable to the environmental dynamics of the entire system.

Some embodiments are based on the recognition that the current state of the vehicular environment can be represented by states, i.e. positions and velocities, of the vehicles in a region under control. However, positions and velocities of vehicles do not represent the entire environment and, thus, data-driven control methods that are based on tracking positions of the control vehicles may be ineffective.

To that end, some embodiments replace state-based control of traffic with control based on a traffic flow. In general, traffic flow, can define interactions of travelers (including pedestrians, cyclists, drivers, and their vehicles) and infrastructure (including highways, signage, and traffic control devices) between themselves by labeling each element appropriately and representing the element as a particle in a flow. The traffic flow can better capture the state of the traffic on the roads than just states of vehicles. Moreover, traffic flow is an aggregation of the general state of the traffic; traffic flow is more detailed than vehicle state estimates and can account for different types of mobility, not limited to vehicles; traffic flow is less sensitive to the accuracy of estimation of vehicle states and can account for uncertainties and/or the probabilistic nature of traffic sensor data.

For example, traffic flow provides density values of traffic that indicate the number of vehicles per unit of space. Density values can be a useful aggregate of the state of the traffic in addition or alternatively to just the positions or even the states of vehicles. In such a manner, some embodiments replace tracking vehicles with tracking density of the traffic flow at each location at the control region.

However, some embodiments are based on recognition that, by itself, traffic flow is ill-suited to work with data-driven control methods. Traffic flow data can have different dimensions at different points of time, which can complicate the training process of the data-driven control methods. In addition, traffic flow abolishes the notion of individual vehicles, while control is applied to individual vehicles. For example, while a reinforcement learning (RL) is a data-driven technique suitable to control traffic, RL is typically used to control agents which have been prespecified by design. It is not practical to apply RL in this way to traffic, since individual vehicles would have to be tracked throughout the system and kept in memory. This, although possible, is far from efficient or desirable in large-scale application such as that to a city.

Indeed, data-driven control of traffic in a region allows decentralized control on a region-by-region basis. However, the region-based traffic control creates an open-ended control system. The controlled machines such as autonomous and/or semi-autonomous vehicles can enter and exit the control region, and thus, can enter and exit the control system making it open-ended. In general, data driven methods need to know (track) their controlled subjects. Hence, data-driven methods are ill-suited to control open-ended systems.

Some embodiments address the problem of controlling an open-ended system using an attention-based control. The attention-based controller of some embodiments is trained to focus attention on one or group of controlled machines in the region and generate a control command for a controlled machine under attention, the selection allowing to focus controller's attention transformed tracking of controlled machine into an input parameter of control. Regardless of which controlled machine is under attention, at each particular step of control, the traffic system with focused attention is a closed-ended system.

Some implementations do not require the controller to continuously control all machines in the region of control. The machines are programmed to receive control commands to follow but that do not need to be regularly updated. The controlled machines may even override a command under certain circumstances. For example, around the same time, the controller may choose to send a routing command to one vehicle and a desired speed to another vehicle. The controller may then choose to send the first vehicle a desired speed. The second vehicle may find the desired speed unsafe due to the presence of a danger on the road, like a small animal, that is obvious to its vision system but not perceptible to the controller.

In addition, traffic data have different dimensions ill-suited for data-driven training and control. To address these issues, some embodiments pixelate the traffic flow into an image of a fixed dimension. For example, some embodiments transform the flow of the traffic into an image of the traffic flow of a region under control, in which a unit of space forms the pixel of the image of the traffic flow and the values of the densities produced for the unit of space forms the values of the pixel. Notably, such an image of density values of the traffic flow is different from an image of positions. For example, the value of the density for at least some pixels in the image of the traffic flow can be fractional to reflect partial occupancy of the location of the pixel in the observed region and/or probabilistic occupancy of the location of the pixel in the observed region. Using an image of traffic flow, some embodiments determine control commands for controlling traffic in the control region. In some implementations, the control commands can be used as guidance for the vehicles to improve their safety.

In effect, representing an image of a traffic flow in combination of attention-based control allows for decentralized control of an open-ended region alleviating the requirements on tracking the controlled machine in the region and accuracy of collecting traffic data.

In addition, one of the issues addressed by some embodiments is an arrangement of the control system configured for real-time traffic control. For example, some embodiments are based on the recognition that cloud control is impractical to optimally control intersection passing and/or highway merging. Cloud control may not meet real-time constraints of the safety requirement due to the multi-hop communication delay. In addition, the cloud does not have instant information of vehicles, pedestrians and road condition to make optimal decisions. Also, vehicle on-board controllers may not have sufficient information to make an optimal decision, e.g., on-board control does not have information about object movement out of the visible range and cannot receive information from vehicles outside of the communication range.

To that end, some embodiments are based on the realization that the edge devices such as roadside units (RSUs) are feasible control points to make optimal decision on real-time decentralized control of the control regions such as intersection passing or highway merging due to their unique features such as direct communication capability with vehicles, road condition knowledge and environment view via cameras and sensors. In addition, edge devices at a control point such as the intersection or highway merging point can make joint control decision via real-time collaboration and information sharing. To that end, some embodiments apply edge devices to realize real-time edge control.

Hence, some embodiments create an image of a traffic flow in a control region to reduce the need to track individual vehicles coining in or out of the control region. However, this approach also creates a new problem of discontinuity of control. It is possible that a vehicle may enter the control region and the control would change abruptly. To address this issue, some embodiments observe traffic data from a larger area than under the region under control. Therefore, the observed region for which the image of traffic flow is determined covers the region controlled by the edge computing device and at least a section of a neighboring region not controlled by the edge computing device.

Accordingly, one embodiment discloses a traffic control system including a set of edge computing devices, each edge computing device is configured to control a region of traffic. The control regions do not intersect, such that each section of each control region is controlled only by a single edge computing device from the set of edge computing devices. An edge computing device receives traffic data in the control region controlled by the edge computing device and receives traffic data in at least an adjacent section of a neighboring control region controlled by a neighboring edge computing device. The control region and the section of the neighboring control region form an observed region.

The edge computing device transforms the traffic data in the observed region into an image of a traffic flow in the observed region, and determines, from the image of the traffic flow in the observed region, control commands for controlling traffic in the control region. Hence, the edge computing device receives traffic data from the observed region, which is larger than the just control region of the edge computing device, while controlling traffic in the control region. In such a manner, the edge computing device avoids discontinuity of decentralized control.

A value of a pixel in the image of the traffic flow includes densities of flows of different types of traffic at a location in the observed region corresponding to a location of the pixel in the image of the traffic flow. The image of the traffic flow provides richer information in a standardized format, which is advantageous for data-driven control methods. The control commands determined by the edge computing device from the image of the traffic flow can be transmitted to the vehicles traveling within the control region, traffic lights located within the control region, or combination thereof.

In some implementations, the traffic data received by the edge computing device include states of vehicles traveling within the observed region. The state of the vehicles can include one or a combination of positions of vehicles and speeds of vehicles. However, traffic data can include more information such as the positions and velocities of pedestrians, positions of traffic signals, and one or a combination of positions and velocities of other traffic elements. Some of this additional information can be monitored and/or received by the edge computing devices, but not all of it can. For example, non-connected vehicle and pedestrian velocities cannot be received without monitoring them, obtaining their image, and determining the velocity from the image. Instead of relying on the preprocessing of this information, which is likely noisy and susceptible to error, it is better to determine control based on the direct, image-based data. Furthermore, this additional information can be further used for estimating the traffic flow including one or combination of a speed of the traffic flow, the density of the traffic flow indicating a number of vehicles per unit of space in the road map, and a current of the traffic flow indicating a number of vehicles per unit of time. For example, some embodiments determine the traffic flow from the states of the vehicles and a road map of the observed region to produce the density of the traffic flow indicating a number of vehicles per unit of space in the road map or portion of vehicle occupying a unit of space, transform the flow of the traffic into the image of the traffic flow, in which a unit of space forms the pixel of the image of the traffic flow and the value of the densities of different traffic elements produced for the unit of space forms the value of the pixel.

Accordingly, one embodiment discloses a traffic control system for controlling traffic in a region, including a receiver configured to receive traffic data in the control region indicative of states of a set of controlled machines forming the traffic in the control region; a memory configured to store an attention-based controller trained to select a controlled machine from the set of controlled machines to focus attention on the controlled machine and to generate a control command for the controlled machine under attention based on an image of the traffic flow in the control region; a processor configured to transform the traffic data into the image of the traffic flow in the control region; and submit the image of the traffic flow and the states of the controlled machines to the attention-based controller to produce control commands for at least some of the controlled machine in the set; and a transmitter configured to transmit the control commands to the controlled machines.

Another embodiment discloses a method for controlling traffic in a region, wherein the method uses a processor coupled with stored instructions implementing the method, wherein the instructions, when executed by the processor carry out steps of the method, including transforming traffic data in the control region into the image of the traffic flow in the control region; determining control commands for each controlled machine in the control region by submitting the image of the traffic flow and states of the controlled machine to an attention-based controller trained to focus an attention on a controlled machine and to generate a control command for the controlled machine under attention based on the image of the traffic flow in the control region; and transmitting the control commands to the controlled machines.

### BRIEF DESCRIPTION OF THE DRAWINGS

FIG. 1 shows a schematic of a traffic system controlled according to some embodiments.

FIG. 2A shows a general schematic of operations of an attention-based controller according to some embodiments.

FIG. 2B shows example of hierarchy of control commands used by some embodiments.

FIG. 3 shows a distributed arrangement of attention based controllers according to some embodiments.

FIG. 4 shows an example of tracking density of the traffic flow according to some embodiments.

FIG. 5 shows a flow chart of a method for determining an image of the traffic flow according to one embodiment.

FIG. 6 shows a general block diagram of a traffic control system according to some embodiments.

FIG. 7 shows a schematic of training an augmented reinforcement learning controller according to some embodiments.

FIG. 8 shows a block diagram of a system for direct and indirect control of traffic in a region in accordance with some embodiments.

FIG. 9A shows a schematic of a vehicle controlled directly or indirectly according to some embodiments.

FIG. 9B shows a schematic of interaction between the controller receiving controlled commands from the system and the controllers of the vehicle according to some embodiments.

### DETAILED DESCRIPTION

The present disclosure relates to a vehicular traffic system. These traffic systems generally include roads joined together at junctions, which include interchanges and intersections, motorized and non-motorized vehicles, pedestrians, and traffic signals and signs. Some parts of traffic systems include some or all of these elements.

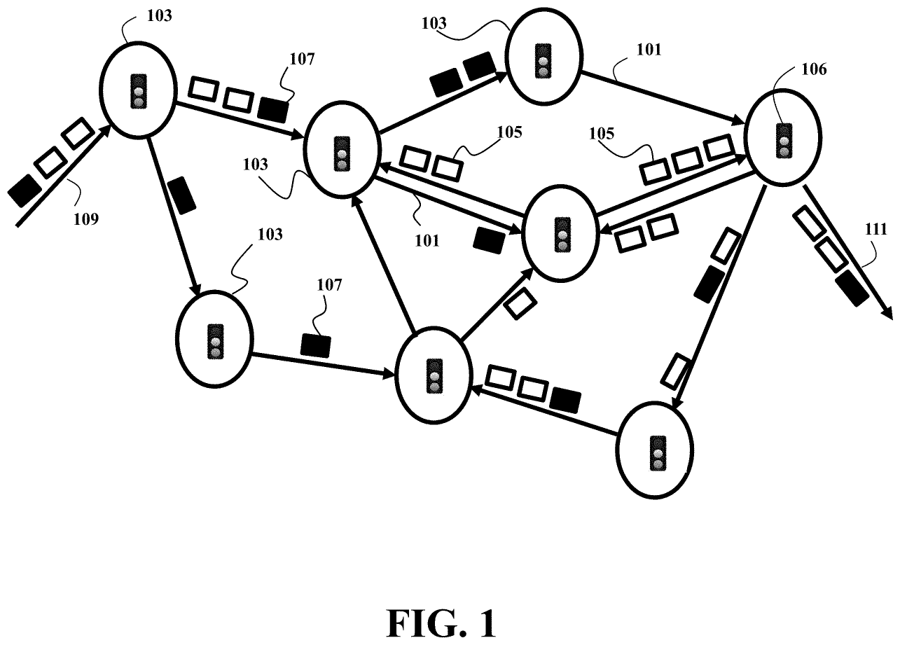

FIG. 1 shows a schematic of a traffic system controlled according to some embodiments. Vehicles that can be controlled 107 follow road segments 101 in traffic with vehicles that are not controlled 105. Traffic signals 106 are placed at road junctions 103. Other objects and traffic participants, such as pedestrians, are not shown but are considered part of the traffic system. Examples of controlled vehicles include autonomous and semi-autonomous vehicles. Examples of uncontrolled vehicles include manually driven vehicles.

The behavior of traffic systems can be dynamically regulated using traffic signals to change the flow of vehicular traffic in a system. With the advent of autonomous vehicles, traffic systems can also be regulated using autonomous vehicles to change the flow of vehicular traffic in a system. Dynamic control of traffic aims to improve the throughput of traffic, minimizing the delay experienced by the average vehicle.

Traffic systems are, by nature, open and not closed. This means that there exist exogenous inflows into and outflows out of the system. Their open nature complicates the use of autonomous vehicles as control mechanisms, since the vehicles themselves can enter and leave the system and their entrances and exits cannot always be controlled. It is therefore not practical to treat an autonomous vehicle as a permanent control mechanism without further modifications. This is in contrast to traffic signals, which are placed at static locations and act as permanent control mechanisms. It therefore becomes important to consider how to treat autonomous vehicles as non-permanent control mechanisms.

The present disclosure provides a solution to the above problem. The system presented herein is composed of subsystems that monitor an area of the traffic system and only send control signals to those control mechanisms that are present in that area. This means that the area covered by one subsystem permanently controls all or some of the traffic signals present in that area but only controls the autonomous vehicles at the time that they are present in that area.

At the best of our knowledge, ordinary control methods are not able to do this type of control. Ordinary control methods determine a control signal for control mechanisms that are permanently placed inside the system. Any alternative method has to consider a method of designing a permanent control mechanism that allows for control of non-permanent controllers.

Indeed, data-driven control of traffic in a region allows decentralized control on a region-by-region basis. However, the region-based traffic control creates an open-ended control system. Controlled machines such as autonomous and/or semi-autonomous vehicles can enter and exit the control region, and thus, can enter and exit the control system making it open-ended. In general, data driven methods need to know, i.e. track, their controlled subjects. Hence, data-driven methods are ill-suited to control the open-ended system.

Some embodiments address the problem of controlling an open-ended system using attention-based control. The attention-based controller of some embodiments is trained to focus the attention on one or group of controlled machines in the region and generate a control command for a controlled machine under attention, the selection allowing to focus controller's attention transformed tracking of controlled machine into an input parameter of control. Regardless of which controlled machine is under the attention, at each particular step of control, the traffic system with focused attention is a closed-ended system.

One implementation of the attention-based controller provides a higher-level control mechanism, which determines the control signals to all control mechanisms in the area of control. Because the lower-level controllers are not necessarily permanent, the super-controller first determines, or selects, a controller before sending an appropriate control signal to it. In this way, the problem of not being able to control non-permanent controllers is avoided, because the attention-based controller itself is a permanent control mechanism.

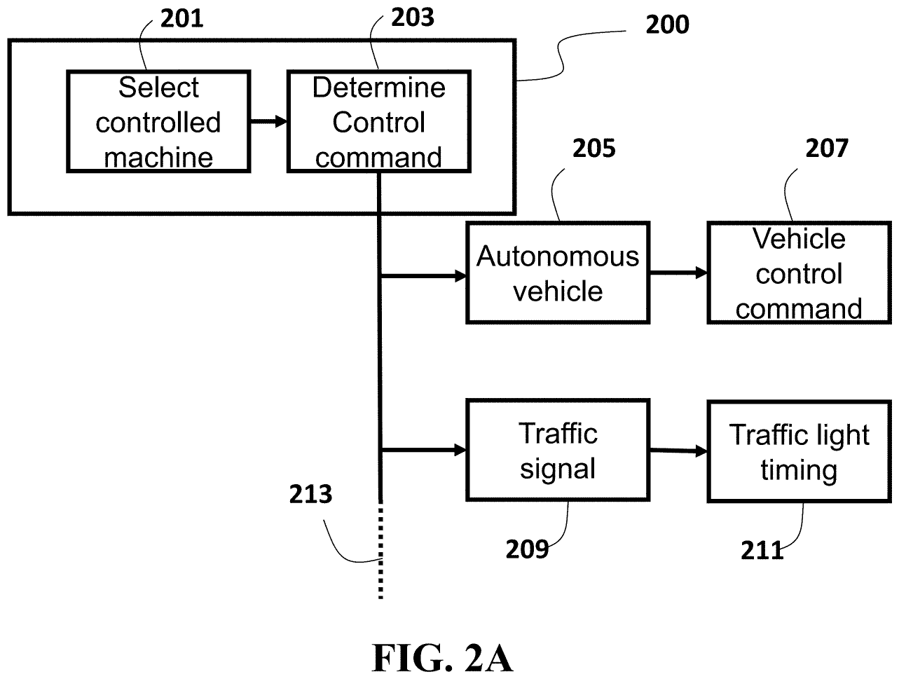

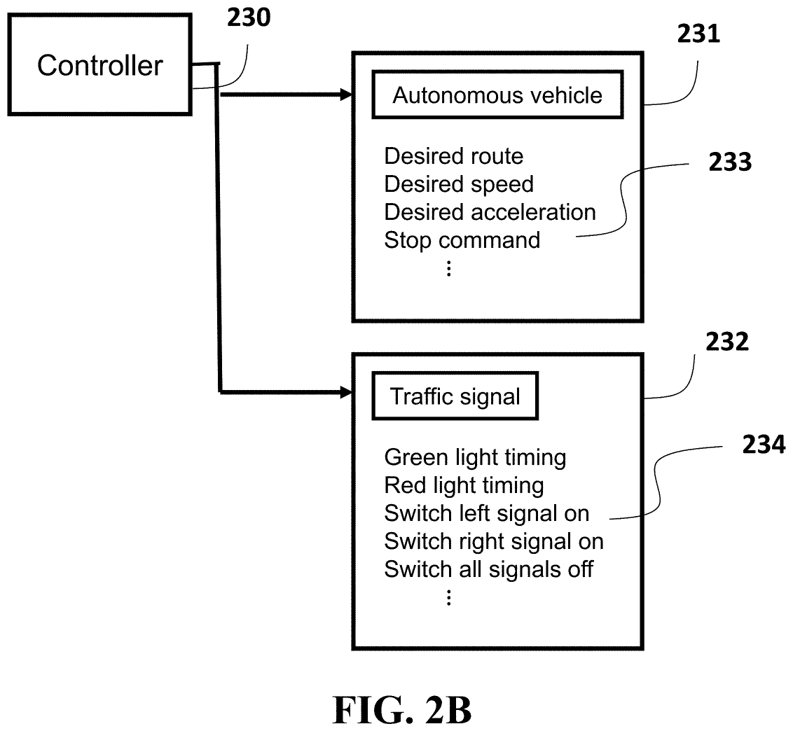

FIG. 2A shows a general schematic of operation of an attention-based controller 200 according to some embodiments. The controller 200 selects 201 a particular controlled machine from a set of controlled machines identified in the control area and generates a control command for the selected controlled machine. Examples of the controlled machine include an autonomous vehicle 205 or a traffic signal 209. The number of control machines that can be chosen is only limited by the number of identifiers that is able to be held in memory at any given time. There could be many more permanent control machines 213 to choose from, including other autonomous vehicles and traffic signals. After focusing attention on the selected control machine, the attention-based controller sends a control command 203 to the selected control machine. In the case of autonomous vehicles, this command is a vehicle control command 207. In the case of traffic signals, this command is a traffic light timing command 211.

Specific vehicle control commands can be grouped into one of two types. The first type are direct controls. A direct vehicle control command is the command for acceleration, braking, and steering given to a vehicle. An indirect command consists of, for example, a recommended route and desired velocity and/or acceleration profile along that route that the vehicle should follow. It can also, for example, be a request to stop the vehicle. In the case of indirect control, the design of the autonomous vehicle has the property that it follows recommended paths with recommended velocity profiles to the extent that is reasonably possible. Between direct and indirect control, indirect is preferred because it allows the lower-level control of individual vehicles to ensure safety requirements, which is more robustly done at the level of individual vehicles.

With indirect control, the controller does not need to continuously control all machines in the region of control, but may choose to do so in some implementations. In some embodiments, the controlled machines are programmed to receive control commands that they are required to follow but that do not need to be regularly updated. They may even override a command under certain circumstances. For example, around the same time, the controller may choose to send a routing command to one vehicle and a desired speed to another vehicle. The controller may then choose to send the first vehicle a desired speed. The second vehicle may find the desired speed unsafe due to the presence of a danger on the road, like a small animal, that is obvious to its vision system but not perceptible to the controller.

FIG. 2B shows an example of hierarchy of control commands used by some embodiments. The first control that must be performed is the selection of a particular control machine, which will either be an autonomous or semi-autonomous vehicle in autonomous mode 231, or a traffic signal 232. The second control to be performed is the selection of a command to be sent to the vehicle, with one type 233 being sent to autonomous vehicles or semi-autonomous in autonomous mode, and another type of command 234 being sent to traffic signals.

The area-based controller solves another problem of traffic systems. Traffic systems are large in scale. For this reason, it is difficult to implement one controller over an entire traffic system without distributing the computations necessary to determine the control signal over multiple computational mechanisms. By implementing one centralized, i.e. non-distributed, controller for every area, we can distribute the control over the entire system by controlling every area separately from other areas. Some embodiments use a communication protocol that allows communication between controllers of adjoining areas. In some embodiments, instead of communicating directly with adjacent controllers, controllers observe an area larger than the area that they cover. In this way, the controllers are able to respond to control actions being taken by controllers with which they do not or cannot communicate. This latter technique is advantageous in cases where adjacent controllers are not of the same type, e.g. they are legacy controllers which cannot communicate their logic; in this case, the controllers in one area can monitor and react to the action of controllers in another area without relying on communication.

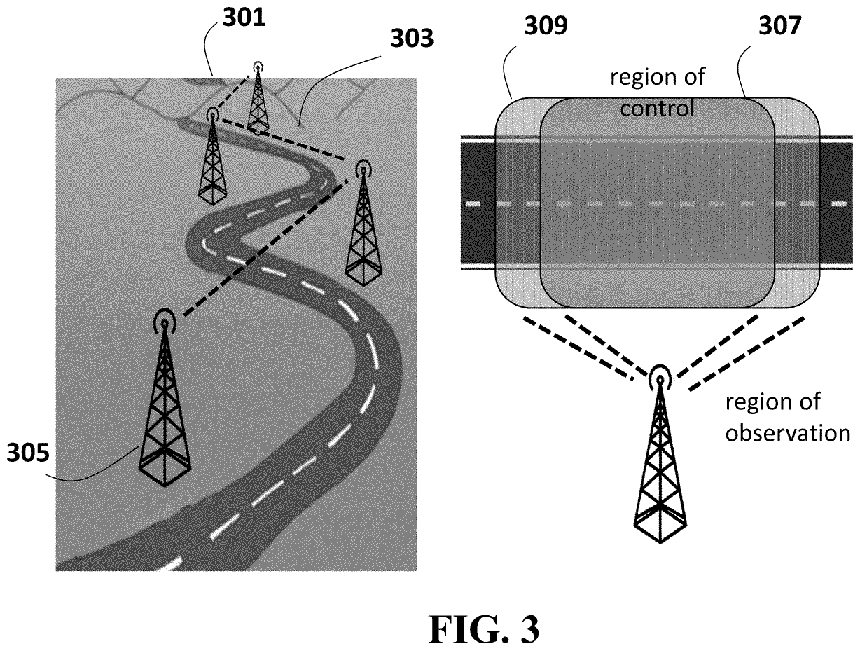

FIG. 3 shows a distributed arrangement of attention-based controllers 301 according to some embodiments. Individual controllers are symbolized by control towers 305 and communicate with adjacent controllers 303. Each controller is responsible for an area or region of control 307. A controller can observer an area larger than the area of control. This is depicted as an area of observation 309. The controllers 305 can be implemented as an edge-computing device.

For example, one embodiment discloses a traffic control system including a set of edge computing devices, where each edge-computing device is configured to control a region of traffic. The control regions do not intersect, such that each section of each control region is controlled only by a single edge-computing device from the set of edge-computing devices. An edge-computing device receives traffic data in the control region controlled by the edge-computing device and receives traffic data in at least an adjacent section of a neighboring control region controlled by a neighboring edge computing device. The control region and the section of the neighboring control region form an observed region.

The edge-computing device transforms the traffic data in the observed region into an image of a traffic flow in the observed region, and determines, from the image of the traffic flow in the observed region, control commands for controlling the traffic in the control region. Hence, the edge computing device receives traffic data from the observed region, which is larger than the just control region of the edge computing device, while controlling traffic in the control region. In such a manner, the edge-computing device avoids discontinuity of decentralized control.

The use of an area-based control introduces a complication. The state of traffic, i.e. traffic flow, is dynamic and is not guaranteed to remain within the area of control. Moreover, the variables observed by any controller must be fixed. Therefore, in some embodiments the observed variables are not individual vehicles since individual vehicles can enter and exit the system. Therefore, some embodiments modify the observed variable to make them remain trackable within the region of observation.

Some embodiments are based on the recognition that the type of variable that can remain trackable in an area is traffic density. For each location on the road, density is related to the number of vehicles in an area around that location. Furthermore, each location has associated with itself a velocity of the vehicle density. Moreover, the density at every location has associated with it derivatives of motion that are higher order than velocity, such as acceleration. Since density and its derivatives of motion can be measured at stationary locations on the road, these variables satisfy the requirement that they be trackable within the area of observation.

A particular solution, implemented in some embodiments, measures the vehicle density at predetermined points on the road. Around each point, an area is fixed and the amount of vehicles in that area are measured. The amount of vehicles, or occupancy, is equal to the amount of area covered by vehicle area divided by the total amount of area:

$$occupancy = \frac{amount of area covered by vehicles}{total amount of area}$$

Occupancy is a coarse measurement of density. Other methods determining vehicle density can be used such as passing the occupancy through a low-pass filter to filter out fluctuations in the observed signal.

Measuring density has the advantage of being able to encode more information about the kind of mix of traffic in the area being observed. For example, an area can be occupied by a controlled, autonomous vehicle, and another kind of vehicle or other type of object such as a non-controlled vehicle, an emergency vehicle, a bicyclist, a pedestrian, and so on. This means that there can exist multiple vehicle occupancies associated with the same point. Each can be measured separately by the observer and tracked.

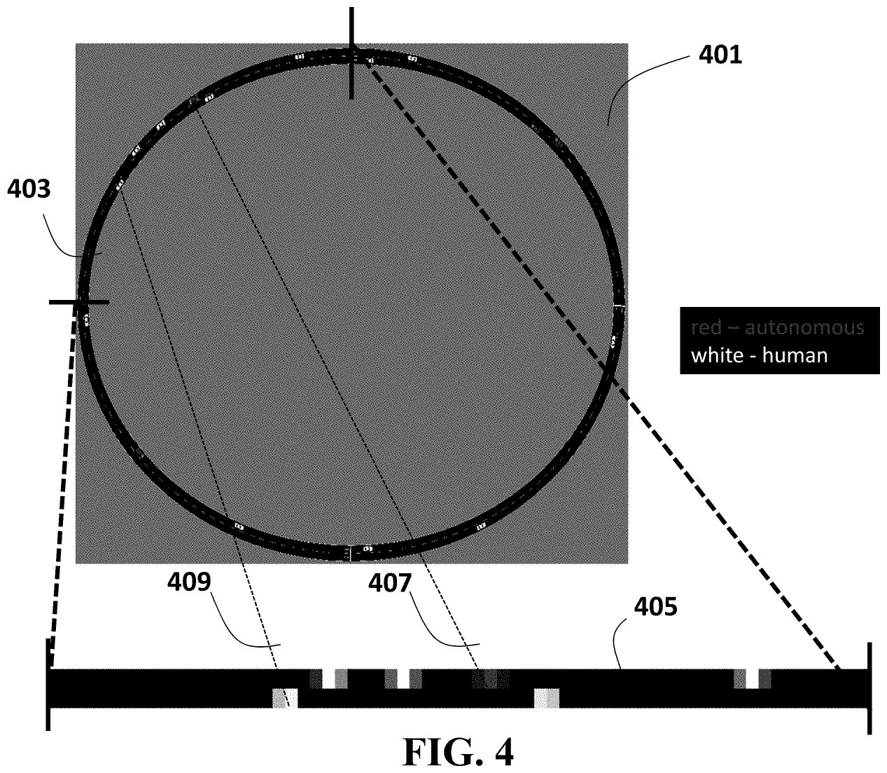

FIG. 4 shows an example of tracking density of the traffic flow according to some embodiments. In this example, traffic on a road segment 403, which is part of a larger traffic network 401, is formed by two types of vehicles: autonomous and non-autonomous. Points on the road segment 403 are associated with some area around the points that measure occupancy of these two types of vehicles. The occupancy is represented by an image 405 which corresponds to the road segment. The color of the area corresponds to the occupancy of autonomous vehicles, which are red and non-autonomous, which are white, and absence of object, which is black. The image is relatively fine enough to see the map between autonomous vehicles 407 and non-autonomous vehicles 409.

In some embodiments, the area around the points is larger. In general, there are no limits to the size of the area. One embodiment uses a 3 m-by-3 m square area because it is fine enough to see granularity between vehicles but coarse enough to avoid redundancy in data.

In such a manner, some embodiments transform the traffic data into an image of the traffic flow in the control region. The image of the traffic flow allows the representation of dynamics of traffic using a vector of fixed dimension. In some embodiments, a value of a pixel in the image of the traffic flow includes a density of the traffic flow at a location of the control region corresponding to a location of the pixel in the image of the traffic flow. The density simplifies the estimation of the image of the traffic flow. For example, some embodiments determine the traffic flow from the states of the vehicles and a road map of the observed region to produce the density of the traffic flow indicating a number of vehicles per unit of space in the road map or portion of vehicle occupying a unit of space, transforming the flow of the traffic into the image of the traffic flow, in which a unit of space forms the pixel of the image of the traffic flow and the value of the densities of different traffic elements produced for the unit of space forms the value of the pixel.

Different embodiments can determine the traffic flow in different manners. For example, one embodiment determines the traffic flow by solving an ordinary differential equation (ODE) modeling interaction of objects having the states of the vehicles. Another embodiment determines the traffic flow using fluid dynamics by solving a system of partial differential equations that balances the density of the traffic flow in accordance with interaction of objects having the states of the vehicles. Yet another embodiment determines density probabilistically to account for uncertainties of traffic estimation. For example, in some implementations, the embodiment computes a probabilistic function that expresses a probability of having a vehicle at time t in a position x traveling with a speed V conditioned on the states of the vehicles; and determines the density of the traffic flow according to the probabilistic function expressing probabilistic occupancy of the locations in the observed region.

To that end, in some embodiments, the value of the density for at least some pixels in the image of the traffic flow is fractional, reflecting partial occupancy of the location of the control region corresponding to the location of the pixel. Additionally, or alternatively, the fractional values of the density can reflect probabilistic occupancy of the location of the control region corresponding to the location of the pixel.

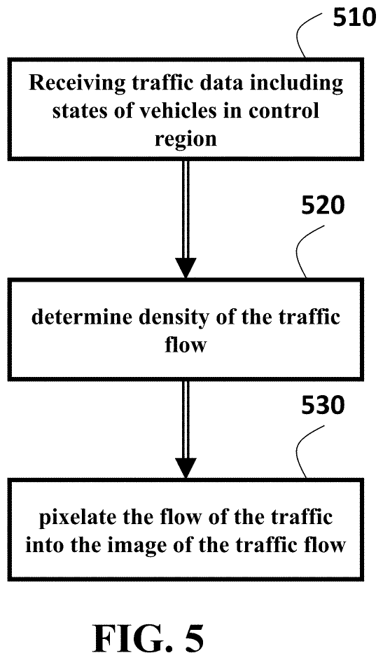

FIG. 5 shows a flow chart of a method for determining an image of the traffic flow according to one embodiment. The embodiment receives 510 traffic data including states of vehicles traveling within the control region. The embodiment determines 520 the traffic flow from the states of the vehicles and a road map of the observed region to produce the density of the traffic flow indicating a number of vehicles per unit of space in the road map, and pixelate 530 the flow of the traffic into the image of the traffic flow, such that a unit of space forms the pixel of the image of the traffic flow and the value of the density produced for the unit of space forms the value of the pixel.

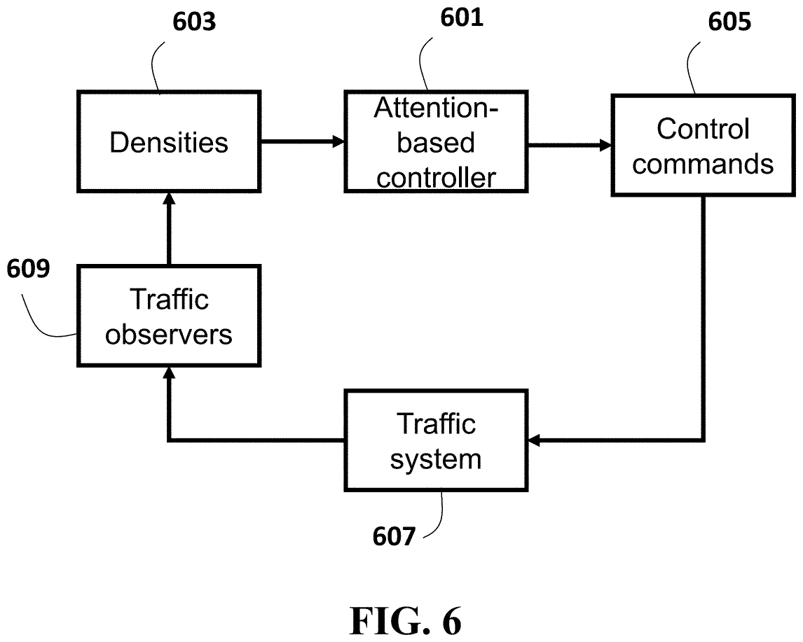

FIG. 6 shows a general block diagram of a traffic control system according to some embodiments. The attention-based controller 601 receives densities 603, which are obtained via traffic observers 609, and determines a control command 605. The commands affect the traffic system 607, which is observed by the traffic observers 609.

Various observers can be used to observe traffic and determine density as described above. These observers can include camera systems, which convert images of traffic to occupancies; on-board systems inside vehicles, which report GPS coordinates to the central controller, which is converted to density information; data from cell-phone towers, which report triangulated position coordinates to the central controller, which is converted to density information; or data from loop-detector sensors placed on the road, which is converted to density information.

A large amount of complexity is introduced by the need to select non-permanent controllers and determine control signals for the same controllers; a control mechanism that is particularly suitable for this kind of complexity is one based on deep reinforcement learning (DRL). DRL solves an on-line optimization to simultaneously learn the behavior of a system and learn to control the same system. DRL is flexible and can be applied to control of controllers, since the method itself is not limited to any kind of control. In general, DRL methods receive a state of a system and determine an action from some predetermined action space. For example, in one embodiment, the action space is the selection mechanism and the available control inputs for that particular controller.

Some embodiments design the DRL to perform control in a decentralized framework. In particular, there exist two possibilities: neighboring DRL-enabled controllers can share their own actions with each other in a method called fingerprinting, or a DRL-enabled controller can partially observe the state of a neighboring area in order to determine its own control. Both kinds of approaches lead to a scalable, decentralized control.

Generally, DRL algorithms attempt to maximize some value function by determining a control action. Here, the value function V is the sum of the reward function over all observed vehicles and a planning horizon of time T:

V=−Σₜ₌₁^{T}Σ_{i∈A}rⁱ

where A is the set of observed vehicles. The control action is the selector and command determination action shown in FIG. 4.

In one embodiment, the reward rᵢ for a specific vehicle is given by:

rᵢ=C^{d}^{ᵢ}−1

for some constant C, where dᵢ is the delay function. The delay function is given as:

dᵢ=max{0,1−vᵢ/v_{f}}

where vᵢ is the speed of the vehicle and v_{f} is the free-flow speed of the road segment on which the vehicle is traveling, which is determined by design. By design, the delay takes a minimum value of 0 when the vehicle speed is above or equal to free-flow speed and a maximum value of 1 when the vehicle is stopped. The form of the reward is chosen to ensure that large delays are penalized more than small delays. Therefore C is a small constant that is strictly greater than 1. In experimentation, a good choice for C was determined to lie between 2 and 3.

The reward is determined for vehicles whose speeds are measured. In general, controlled vehicles can be measured and, additionally, some other vehicles may report their speeds to the controller.

The input to an RL controller is the system state, and the output is an action. RL controllers do not know the relationship between state and action and trained to find how to exploit the relationship to maximize the desired reward. In one embodiment, the state consists of an image of traffic density and a list of positions of autonomous vehicles. The positions of autonomous vehicles are required so that the controller may know the location of this controlled mechanism and learn how its actions relate to the positions of vehicles in the system. The actions are the control commands including selection 201 and commands to the controlled machine 203. In RL controllers, as is the case for most controllers, the set of actions must be predetermined and fixed. The set of actions is therefore defined as

A={a₀,aₐ,a_{a,0},a_{a,1}, . . . ,aₛ,a_{s,0},a_{s,1}, . . . }

where a₀ is the action of selecting a controlled machine, which may be an autonomous vehicle or semi-autonomous vehicle in autonomous mode, a traffic signal, or none; aₐ is the action of selecting which command to send to an autonomous vehicle; a_{a,i} are the actions corresponding to autonomous vehicles with a_{a,i} being sent only if aₐ=i; aₛ is the action of selecting which command to send to a traffic signal; and a_{s,i} are actions corresponding to traffic signals with a_{s,i} being sent only if aₛ=i. Based on the type of controlled machine selected, either actions aₐ or aₛ will be available to the controller. Furthermore, only the i-th action will be available if aₐ or aₛ is equal to i. Since an RL controller has to determine a value for all actions in the set of actions, it is through training of the RL algorithm that the controller learns whether an action will have any effect on the system after performing the selection action. This gives the RL controller the necessary behavior of first selecting the controlled machine and then specific sub-commands.

For every control step, the controller can be invoked never, once, or multiple times. The controller is invoked until the action a₀ is equal to none or until the all controlled machines have been sent a command.

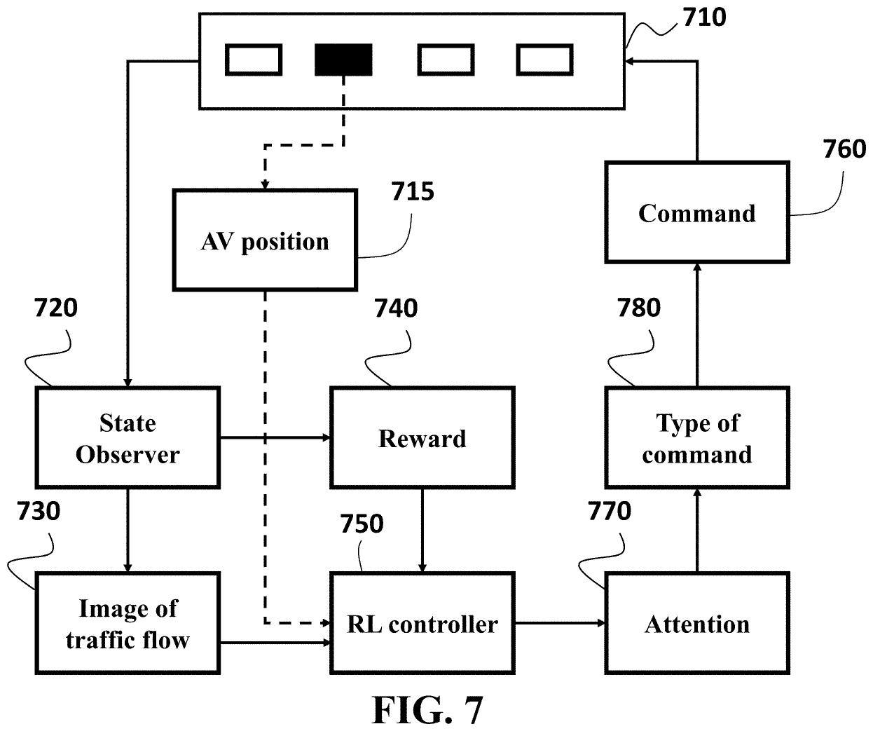

FIG. 7 shows a schematic of training a reinforcement learning controller according to some embodiments. In reinforcement learning (RL), the RL controller 750 interacts with its environment 710 in discrete time steps. At each time t, the RL controller receives an observation 720 of a traffic state 330 in the environment 710, the positions of all autonomous vehicles it can control 715, and the reward 740. The traffic state is transformed into an image of a traffic flow 730. Ultimately, the RL controller 750 is used to select an action 760 from the set of available actions, which is subsequently sent to the environment as a control command to change the traffic state in the environment. The actions are selected to collect as much reward as possible and the reward is determined to encourage the platoon formation.

The RL controller is not trained to just output commands, but also trained to focus attention 770 on one or a group of vehicles in the control region and to determine an action or control command 760 for the vehicle under attention. For a control step, one embodiment invokes the attention-based controller repeatedly until the attention focus is none or all controlled machines have been sent a command. Additionally, or alternatively, one embodiment invokes the attention-based controller only once per control step. Additionally, or alternatively, one embodiment invokes the attention-based controller multiple times per control step but without a requirement to process all controlled machine at each control step.

The controlled machines include at least a subset of vehicles traveling within the control region, at least one traffic light located within the control region, or combination thereof. Because different controlled machines have different types, each type of the controlled machine is associated with types of the control commands 780. The attention-based controller is trained to determined control commands of a type corresponding to a type of the controlled machine under the attention. For example, in one embodiment, a deep reinforcement learner (DRL) 750 determines a value for each action in its set of actions. Based on which actions were chosen, a command is sent only if it corresponds to the attention focus action 770 and the action determining the type of command to send 760. There is only one particular command, if any, that is sent 760 at every time step.

Different embodiments use different methods to train the parameterized function forming the RL controller. For example, in some embodiments, the parameterized function is trained using one of a deep deterministic policy gradient method, advantage-actor critic method, proximal policy optimization method, deep Q-network method, or Monte Carlo policy gradient method.

### Exemplar Embodiments

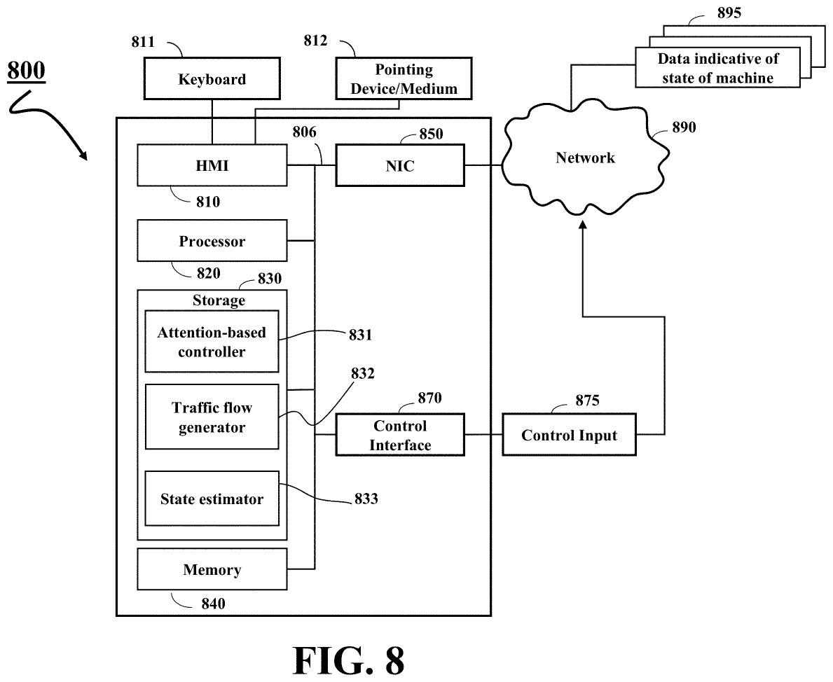

FIG. 8 shows a block diagram of a system 800 for direct and indirect control of traffic in a region in accordance with some embodiments. The system 800 can have a number of interfaces connecting the system 800 with other machines and devices. A network interface controller (NIC) 850 includes a receiver adapted to connect the system 800 through the bus 806 to a network 890 connecting the system 800 with the mixed-automata vehicles to receive a traffic state of a group of mixed-autonomy vehicles traveling in region. The group of mixed-autonomy vehicles includes one or combination of controlled vehicles and uncontrolled vehicle. The network 890 can connect the system 800 with other types of the controlled machines in the control region, such as traffic lights.

In some embodiments, the receiver is configured to receive traffic data for an observed region larger than the control region, such that the control region forms a portion of the observed region, wherein the attention-based controller trained to generate the control command for the controlled machine under attention based on the image of the traffic flow in the observed region, wherein the processor is configured to transform the traffic data into the image of the traffic flow in the observed region for usage in the attention-based controller.

The NIC 850 also includes a transmitter adapted to transmit the control commands to the controlled machines via the network 890. To that end, the system 800 includes an output interface, e.g., a control interface 870, configured to submit the control commands 875 to the controlled machines through the network 890. In such a manner, the system 800 can be arranged on a remote server in direct or indirect wireless communication with the mixed-automata vehicles.

The system 800 can also include other types of input and output interfaces. For example, the system 800 can include a human machine interface 810. The human machine interface 810 can connect the controller 800 to a keyboard 811 and pointing device 812, wherein the pointing device 812 can include a mouse, trackball, touchpad, joy stick, pointing stick, stylus, or touchscreen, among others.

The system 800 includes a processor 820 configured to execute stored instructions, as well as a memory 840 that stores instructions that are executable by the processor. The processor 820 can be a single core processor, a multi-core processor, a computing cluster, or any number of other configurations. The memory 840 can include random access memory (RAM), read only memory (ROM), flash memory, or any other suitable memory machines. The processor 820 can be connected through the bus 806 to one or more input and output devices.

The processor 820 is operatively connected to a memory storage 830 storing the instruction as well as processing data used by the instructions. The storage 830 can form a part of or be operatively connected to the memory 840. For example, the memory can be configured to store an attention-based controller 831 trained to generate a control command for a controlled machine under attention based on an image of the traffic flow in the control region.

The processor 820 is configured to determine control commands for the controlled vehicles to control them directly or indirectly. To that end, the processor is configured to execute a traffic flow generator 832 to transform the traffic data into the image of the traffic flow in the control region and execute state estimator 833 to identify states controlled machines in the control region. For example, the state estimator can extract the state of the controlled machine from the traffic data 895. Additionally, or alternatively, states of the stationary machine can be submitted through the HMI 810. Examples of states include position of the controlled machine, such as positions of the vehicles at current control step and permanent positions of the traffic lights.

The processor is further configured to submit the image of the traffic flow and the states of the controlled machines to the attention-based controller 831 to produce control commands for at least some of the controlled machine. The attention-based controller 831 is trained to select a controlled machine from the set of controlled machines identified by the set of states to focus attention on the controlled machine and to generate a control command for the controlled machine under attention based on an image of the traffic flow in the control region. In some embodiments, the attention-based controller 831 is a deep reinforcement learning (DRL) controller having an attention module focusing the attention of the attention-based controller on different controlled machines.

For a control step that for example can be defined by the image of the traffic flow, the attention-based controller produces the control commands for none, one or multiple controlled machines until a termination condition is met. For example, the termination condition includes one or combination of a control condition testing whether all controlled machines in the set are placed under attention to generate the control commands and a time condition testing whether a time period allocated for the control step is expired. The attention on specific machine during a specific control step, type of the command and number of execution are learned by the attention-based controller during the training.

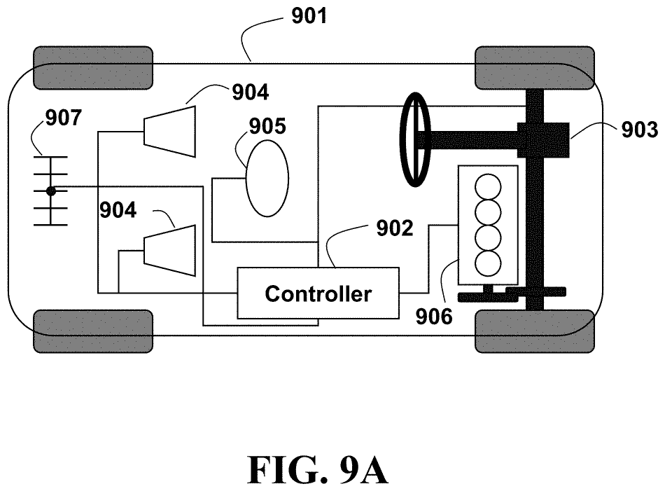

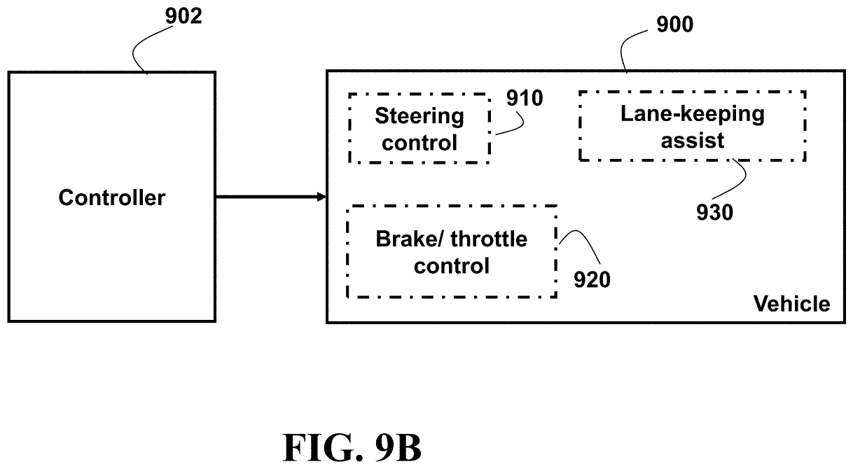

FIG. 9A shows a schematic of a vehicle 901 controlled directly or indirectly according to some embodiments. As used herein, the vehicle 901 can be any type of wheeled vehicle, such as a passenger car, bus, or rover. Also, the vehicle 901 can be an autonomous or semi-autonomous vehicle. For example, some embodiments control the motion of the vehicle 901. Examples of the motion include lateral motion of the vehicle controlled by a steering system 903 of the vehicle 901. In one embodiment, the steering system 903 is controlled by the controller 902 in communication with the system 800. Additionally, or alternatively, the steering system 903 can be controlled by a driver of the vehicle 901.

The vehicle can also include an engine 906, which can be controlled by the controller 902 or by other components of the vehicle 901. The vehicle can also include one or more sensors 904 to sense the surrounding environment. Examples of the sensors 904 include distance range finders, radars, lidars, and cameras. The vehicle 901 can also include one or more sensors 905 to sense its current motion quantities and internal status. Examples of the sensors 905 include global positioning system (GPS), accelerometers, inertial measurement units, gyroscopes, shaft rotational sensors, torque sensors, deflection sensors, pressure sensor, and flow sensors. The sensors provide information to the controller 902. The vehicle can be equipped with a transceiver 907 enabling communication capabilities of the controller 902 through wired or wireless communication channels.

FIG. 9B shows a schematic of interaction between the controller 902 receiving controlled commands from the system 800 and the controllers 900 of the vehicle 901 according to some embodiments. For example, in some embodiments, the controllers 900 of the vehicle 901 are steering 910 and brake/throttle controllers 920 that control rotation and acceleration of the vehicle 900. In such a case, the controller 902 outputs control inputs to the controllers 910 and 920 to control the state of the vehicle. The controllers 900 can also include high-level controllers, e.g., a lane-keeping assist controller 930 that further process the control inputs of the predictive controller 902. In both cases, the controllers 900 maps use the outputs of the predictive controller 902 to control at least one actuator of the vehicle, such as the steering wheel and/or the brakes of the vehicle, in order to control the motion of the vehicle. States xₜ of the vehicular machine could include position, orientation, and longitudinal/lateral velocities; control inputs uₜ could include lateral/longitudinal acceleration, steering angles, and engine/brake torques. State constraints on this system can include lane keeping constraints and obstacle avoidance constraints. Control input constraints may include steering angle constraints and acceleration constraints. Collected data could include position, orientation, and velocity profiles, accelerations, torques, and/or steering angles.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A traffic control system for controlling traffic in a region, comprising:
a receiver configured to receive traffic data in the control region indicative of states of a set of controlled machines forming the traffic in the control region;
a memory configured to store an attention-based controller trained to select a controlled machine from the set of controlled machines to focus attention on the controlled machine and to generate a control command for the controlled machine under attention based on an image of the traffic flow in the control region;
a processor configured to transform the traffic data into the image of the traffic flow in the control region; and submit the image of the traffic flow and the states of the controlled machines to the attention-based controller to produce control commands for at least some of the controlled machine in the set; and
a transmitter configured to transmit the control commands to the controlled machines.

2. The traffic control system of claim 1, wherein, for a control step, the attention-based controller produces the control commands until a termination condition is met, wherein the termination condition includes one or combination of a control condition testing whether all controlled machines in the set are placed under attention to generate the control commands and a time condition testing whether a time period allocated for the control step is expired.

3. The traffic control system of claim 1, wherein the controlled machines include at least a subset of vehicles traveling within the control region, at least one traffic light located within the control region, or combination thereof.

4. The traffic control system of claim 1, wherein different controlled machines have different types, each type of the controlled machine is associated with types of the control commands, wherein the attention-based controller is trained to determined control commands of a type corresponding to a type of the controlled machine under the attention, and wherein the processor determines and submits the type of the controlled machine under the attention to the attention-based controller.

5. The traffic control system of claim 1, wherein the attention-based controller is a deep reinforcement learner (DRL) augmented with an attention module focusing the attention of the attention-based controller on different controlled machines.

6. The traffic control system of claim 1, wherein the receiver is configured to receive traffic data for an observed region larger than the control region, such that the control region forms a portion of the observed region, wherein the attention-based controller trained to generate the control command for the controlled machine under attention based on the image of the traffic flow in the observed region, wherein the processor is configured to transform the traffic data into the image of the traffic flow in the observed region for usage in the attention-based controller.

7. The traffic control system of claim 1, wherein a value of a pixel in the image of the traffic flow includes a density of the traffic flow at a location of the control region corresponding to a location of the pixel in the image of the traffic flow.

8. The traffic control system of claim 7, wherein the value of the density for at least some pixels in the image of the traffic flow is fractional to reflect partial occupancy of the location of the control region corresponding to the location of the pixel.

9. The traffic control system of claim 7, wherein the value of the density for at least some pixels in the image of the traffic flow is fractional to reflect probabilistic occupancy of the location of the control region corresponding to the location of the pixel.

10. The traffic control system of claim 1, wherein the traffic data include states of vehicles traveling within the control region, wherein the processor is configured to
determine the traffic flow from the states of the vehicles and a road map of the observed region to produce the density of the traffic flow indicating a number of vehicles per unit of space in the road map; and
pixelate the flow of the traffic into an image of the traffic flow, wherein a unit of space forms the pixel of the image of the traffic flow and the value of the density produced for the unit of space forms the value of the pixel.

11. The traffic control system of claim 10, wherein the states of the vehicles include positions of the vehicles and speeds of the vehicles, and wherein the processor uses positions and speeds of the vehicles to estimate variables of the traffic flow including speed of the traffic flow, density of the traffic flow, and current of the traffic flow indicating a number of vehicles per unit of time.

12. The traffic control system of claim 1 forming an edge computing device.

13. A set of edge computing devices, wherein each edge computing device includes the traffic control system of claim 1 to control the region of the traffic, wherein the control regions do not intersect, such that each section of each control region is controlled only by a single edge computing device from the set of edge computing devices.

14. The set of edge computing devices of claim 13, wherein the input interface of each edge computing device is configured to receive traffic data in at least an adjacent section of a neighboring control region controlled by a neighboring edge computing device, such that the control region and the section of the neighboring control region form an observed region, wherein the observed region of the edge computing device is larger than the control region of the edge computing device, wherein the attention-based controller trained to generate the control command for the controlled machine under attention based on the image of the traffic flow in the observed region, and wherein the processor is configured to transform the traffic data into the image of the traffic flow in the observed region for usage in the attention-based controller.

15. The traffic control system of claim 1, wherein the set of controlled machines is identified from the traffic data.

16. The traffic control system of claim 1, wherein identities of at least some of the controlled machines in the set are transmitted by the controlled machines and received by the receiver.

17. The traffic control system of claim 1, wherein the control command for the controlled machine is a high-level command for guiding a low-level controller of the controlled machine.

18. The traffic control system of claim 17, wherein the controlled machine is an autonomous vehicle, and wherein the high-level command includes one or combination of a desired route, a desired speed, and a desired acceleration command.

19. The traffic control system of claim 1, wherein the controlled machine is a traffic light, and wherein the high-level command includes one or combination of a green light timing, a red light timing, a switch left signal on, a switch right signal on, and a switch all signals off command.

20. A method for controlling traffic in a region, wherein the method uses a processor coupled with stored instructions implementing the method, wherein the instructions, when executed by the processor carry out steps of the method, comprising:
transforming traffic data in the control region into the image of the traffic flow in the control region;
determining control commands for each controlled machine in the control region by submitting the image of the traffic flow and states of the controlled machine to an attention-based controller trained to focus an attention on a controlled machine and to generate a control command for the controlled machine under attention based on the image of the traffic flow in the control region; and
transmitting the control commands to the controlled machines.
